(19) United States
(12) Patent Application Publication
(10) Pub. No.: US 2003/0189871 A1
(43) Pub. Date: Oct. 9, 2003

(54) Mixing chamber of mixing tow or more liquids under high velocity to produce a solid particle dispersion

(75) Inventors: M. Christine Brick, Webster, NY (US); Harvey J. Palmer, Lima, NY (US); Lloyd A. Lobo, Webster, NY (US); Richard R. Messner, Rochester, NY (US); Thomas L. Pike, Victor, NY (US); Thomas H. Whitesides, Cambridge, MA (US)

Correspondence Address: Thomas H. Close, Patent Legal Staff, Eastman Kodak Company, 343 State Street, Rochester, NY, 14650-2201, US

(73) Assignee: Eastman Kodak Company

(21) Appl. No.: 10/119,249

(22) Filed: Apr. 9, 2002

(51) Int. Cl. B01F 5/02

(52) U.S. Cl. 366/162.4; 366/176.1

(57) ABSTRACT

The present invention is an apparatus and method designed to allow the reaction of two or more liquids through collision as separate jets within a mixing chamber with a small residence time to produce a sub-micron solid particle dispersion. The liquid jet impingement is achieved by pumping each liquid separately at a high flow rate though an orifice, that produces a high-velocity stream that collides with the opposing jet of another stream and dispenses the final sub-micron solid particle dispersion without restriction immediately upon mixing into a bulk stabilizer solution.

### FIELD OF THE INVENTION

This invention relates to the mixing of at least two liquids which form a dispersion of sub-micron particles upon mixing, and more particularly, to mixing of the liquids under high velocity and high-energy conditions for forming a sub-micron precipitate in the dispersion.

### BACKGROUND OF THE INVENTION

The production of solid particle dispersions of materials by mixing two liquids to produce an insoluble precipitate is well known in the art. In one type of precipitation technique, called solvent shifting, the solute is dissolved in a liquid and combined with another liquid that is a non-solvent for the solute material. When the two liquid streams are combined, the composition of the final liquid phase will be below the solubility of the solute, which precipitates as a solid particle dispersion. This is an alternative method to the more time-consuming method of ball milling the solid in the non-solvent solution to produce solid particle dispersions by size reduction.

A common mixing method employed during batch and semi-batch precipitation processes is to pump the reacting liquids together in the vicinity of a rotating impeller where they are blended with stirring. While this method provides adequate bulk mixing and rapid dispersion of the precipitated particles in the bulk stabilizer solution, the power input imparted to the fluids, and therefore the final dispersion particle size, is limited by the impeller speed and diameter, as described in Chapter 3 of Fluid Mixing Technology by J. Y. Oldshue, McGraw-Hill, New York, 1983. Another mixing method employed during precipitation is the use of a “tee” (or Roughton) mixer junction, as described on p 203 of Precipitation, Basic Principles and Industrial Applications, by O. Sohnel and J. Garside, Butterworth-Heinemann Ltd, Oxford, 1992. In this type of mixer, the reactant streams are introduced as two or more streams from separate channels into a narrow junction, and the resulting product is pumped though a pipe, usually set 90 degrees from the fluid inlet streams. While this method gives more rapid mixing of the reactants and smaller particle sizes than the impeller method, its effectiveness to produce small particles is limited in several ways. The maximum velocity of the fluid is limited due to the fluid drag imparted by the walls of the channels. It is difficult to introduce the two inlet streams at different flow rates and obtain consistent results, since both streams have essentially the same velocity in their collision at the “tee” mixer junction. Finally, the containment of the final dispersion within the exit channel prevents the dispensing of the particles into a larger bulk stabilizer solution of the non-solvent to prevent further particle growth by ripening and agglomeration.

U.S. Pat. No. 4,144,025 discloses the use of solvent shifting to produce dispersions of various organic pigments, which are substantially insoluble in water. In this process, the pigments are precipitated by adding the non-solvent, an aqueous solution containing a surfactant and a polymeric dispersant to a solution of pigment dissolved in a volatile, water-miscible organic solvent, or to a solution of pigment dissolved in a mixture of water and a volatile, water-miscible organic solvent. The volatile organic solvent must be immediately removed from the dispersion to prevent ripening and agglomeration of the particles. U.S. Pat. No. 2,870,012 discloses water-miscible solvent shifting to prepare dispersions of molecular couplers and polymeric couplers. U.S. Pat. Nos. 4,783,484, 4,826,689 and 4,997,454 and 5,780,062 disclose preparing solid particle dispersions of organic materials for pharmaceutical applications by solvent shifting in a batch precipitation process. A specialized precipitation process, called pH shifting, is also used to prepare solid particle dispersions. In this method, weak acids such as pharmaceuticals, organic pigments and dyes are precipitated by the acidification of a concentrated solution of the soluble anionic form of the solute. Precipitation of solid particle organic dyes by pH shifting has been demonstrated in U.S. Pat. Nos. 5,274,109, 5,326,687 and 5,624,467. The precipitation process in all of these examples is conducted either by mixing the reacting liquids in the vicinity of a rotating impeller in a batch mode, or by combining them together in a “tee” mixer junction in continuous mode. As discussed previously, these mixing methods suffer from some or all of the following deficiencies: limited power input which limits the intensity of mixing, inability to directly disperse the particles into a bulk stabilizer fluid as they are formed due to restrictions in the outlet channel, limitations in the maximum fluid velocity due to drag on the walls of the outlet channel, and an inability to manipulate flow rates of the inlet streams independently to produce consistent results.

Several devices disclosed in the prior art are designed for the mixing of miscible fluids. Static or motionless mixers, disclosed in Chapter 19 of Fluid Mixing Technology by J. Y. Oldshue, McGraw-Hill, New York, 1983, are stationary structures contained within a pipe that mix the liquids as the process fluid flows past it. However, the velocities attainable from conventional static mixers are generally too low to produce turbulent mixing, and they require the two liquids to be previously mixed before entering the mixing zone. Variations in design of static mixing devices to increase the turbulence of the mixing zone are disclosed in U.S. Pat. Nos. 4,514,095, 4,043,539, 4,136,976 and 4,361,407. These devices are all designed for miscible fluids that are initially combined before they are introduced into the static mixing zone, and not for combinations of liquids that produce a solid precipitate as a by-product of the reaction. In fact, if they were employed during the solvent shifting process, the precipitate produced could very likely plug the mixing chamber due to the multiplicity of small passages within it.

Several mixing devices disclosed in the prior art are designed to provide a turbulent mixing zone for immiscible liquids that have been previously mixed. These devices accept a flowing fluid composed of two or more immiscible liquids, and uses the energy from the flow of the fluid to create a high shear zone within the fluid to homogenize the liquid into small droplets. High-pressure homogenization is commonly used to produce droplet sizes less than a micron by forcing a mixture of the oil and water through a restriction to produce high-shear forces to disrupt the oil phase, as described by P. Walstra in Chapter 2 of Encyclopedia of Emulsion Technology, VI, Basic Theory, Marcel Dekker Inc., New York, 1983. Variations in the design of the mixing chambers of these homogenizers are disclosed in U.S. Pat. No. 4,124,309 to Yao, U.S. Pat. No. 4,533,254 and U.S. Pat. No. 4,908,154 to Cook and Lagace and U.S. Pat. No. 4,994,242 to Rae and Hauptmann. The high-pressure homogenizer represents the best available technology for blending immiscible liquids to produce small drop sizes. However, this technology is not well suited for producing small particles by solvent shifting because the two liquids need to be blended in advance before entering the high-intensity mixing zone of the homogenizer. When the two liquids are premixed, particles will form immediately, well before they enter mixing zone.

Although the presently known and utilized systems for mixing liquids are satisfactory, they include drawbacks. The impeller used for batch precipitation during solvent shifting provides insufficient power to produce small particles. The “tee” mixer produces small particles, but is limited in the maximum fluid velocity that can be obtained, cannot disperse the fluid directly into the bulk, and one cannot manipulate the flow rates of the fluid streams independently. Existing devices for high pressure homogenization are unacceptable for solvent shifting because they require that the two liquids be blended before entering the mixing chamber.

Consequently, a need exists for a system and method to react two or more liquids in a highly turbulent zone without prior mixture of these streams before entering the mixing zone, so that the byproduct of the reaction is a solid particle dispersion with substantially all particles below 1 micron that can be further dispensed immediately upon mixing into a bulk stabilizer solution without restriction.

### SUMMARY OF THE INVENTION

The present invention is directed to overcome one or more of the problems set forth above. Briefly summarized, according to one aspect of the present invention, a jet impingement mixer for reacting two or more liquids to produce a solid precipitate, the mixer includes (a) a first channel for permitting flow of a first liquid under a first velocity; (b) at least one jet-stream producing mechanism in operative relation to the first channel for dispensing the first miscible liquid therefrom under increased first velocity into a mixing zone; (c) a second channel for permitting flow of a second liquid under a second velocity; (d) at least one jet-stream producing mechanism in operative relation to the second channel for dispensing the second liquid at least one jet-stream producing mechanism in operative relation to the second channel for dispensing the second liquid therefrom into the mixing zone under an increased second velocity into substantial contact with the first liquid into the mixing zone under an increased second velocity into substantial contact with the first liquid, (e) a mixing zone with minimum volume to provide a high kinetic energy in the mixing zone and low residence time of the fluid so that a sub-micron solid precipitate is formed and dispensed immediately after mixing into the bulk stabilizer solution without further restriction. The mixing chamber can also be wholly or partially submerged in the bulk stabilizer solution. In this way, the collision of the liquid steams and production of the precipitate takes place in an extremely small space for a very short time and are immediately dispensed into the bulk stabilizer solution, making it possible to form very small particles that are stable to ripening and agglomeration.

### ADVANTAGES OF THE INVENTION

The advantages of the invention include a high kinetic energy in the mixing zone in order to produce particles substantially under 1 micron from the reacting streams, a low residence time in the mixing chamber to prevent particle agglomeration and growth after the jet streams are mixed, and the immediate dispensation of the resulting sub-micron solid particle dispersion into a bulk stabilizer solution to prevent further particle agglomeration and growth. It is also an advantage that no “dead” regions exist in the mixing zone that contains stagnant fluid. It is also an advantage that the mixing chamber is wholly or partially immersed into the bulk stabilizer solution so that particle stabilization occurs instantaneously after the sub-micron precipitate is formed in the mixing zone. It is also an advantage that the volume of the mixing zone can be varied by interchanging plates with different orifice diameters and shims of varying thickness.

### BRIEF DESCRIPTION OF THE DRAWINGS

FIG. 1a is a perspective view of the mixing chamber apparatus of the present invention for mixing two liquids;

FIG. 1b is a top plan view of FIG. 1a;

FIG. 1c is view along line c-c of FIG. 1b;

FIG. 2 is a view of the mixing chamber immersed in bulk solution;

FIG. 3 is an alternative embodiment in perspective view of the present invention with a portion cutaway for clarity of illustration; and

FIG. 3a is a view along line a-a of FIG. 3.

### DETAILED DESCRIPTION OF THE INVENTION

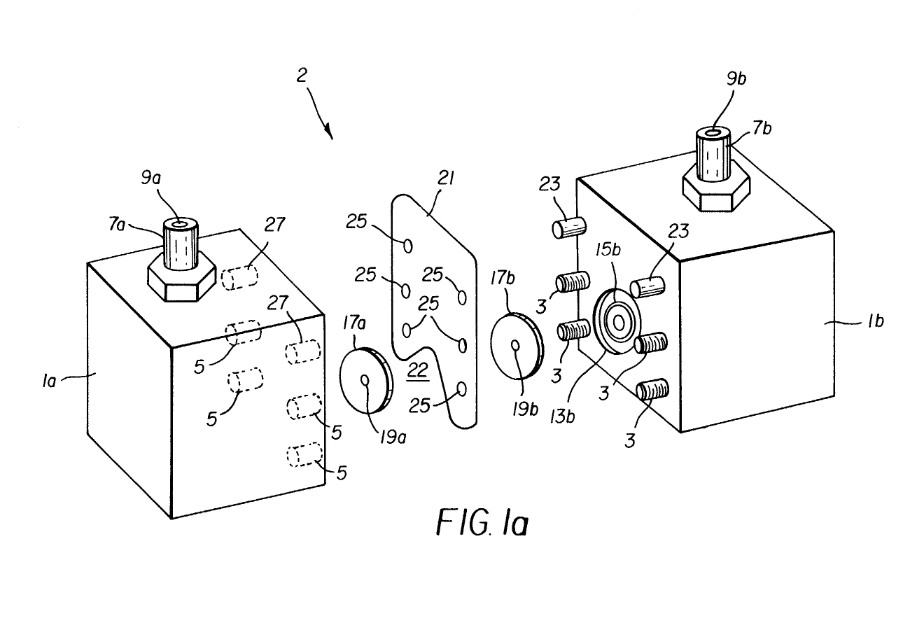

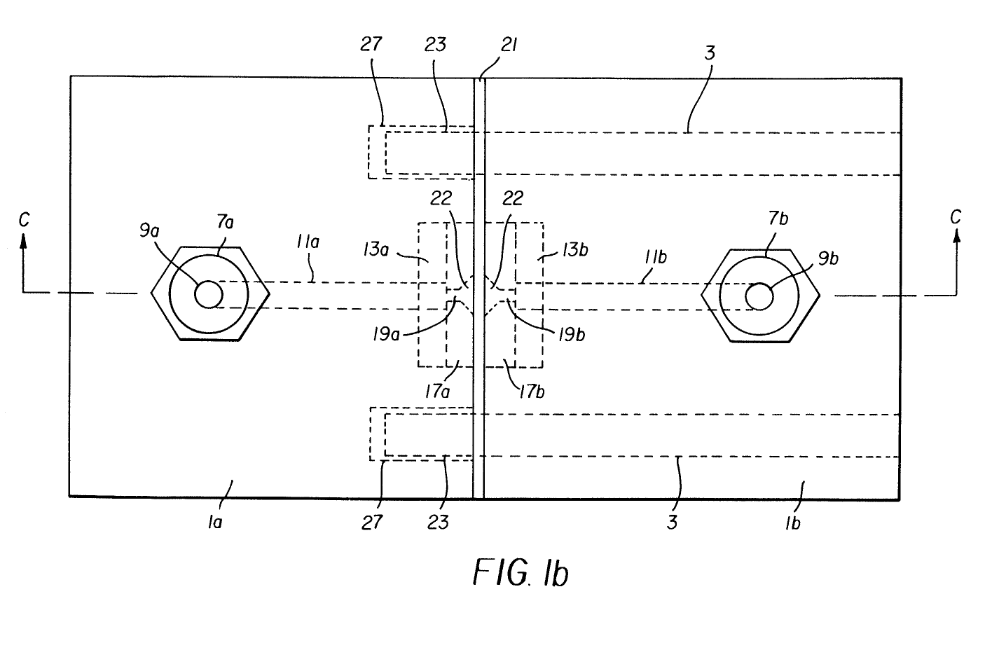

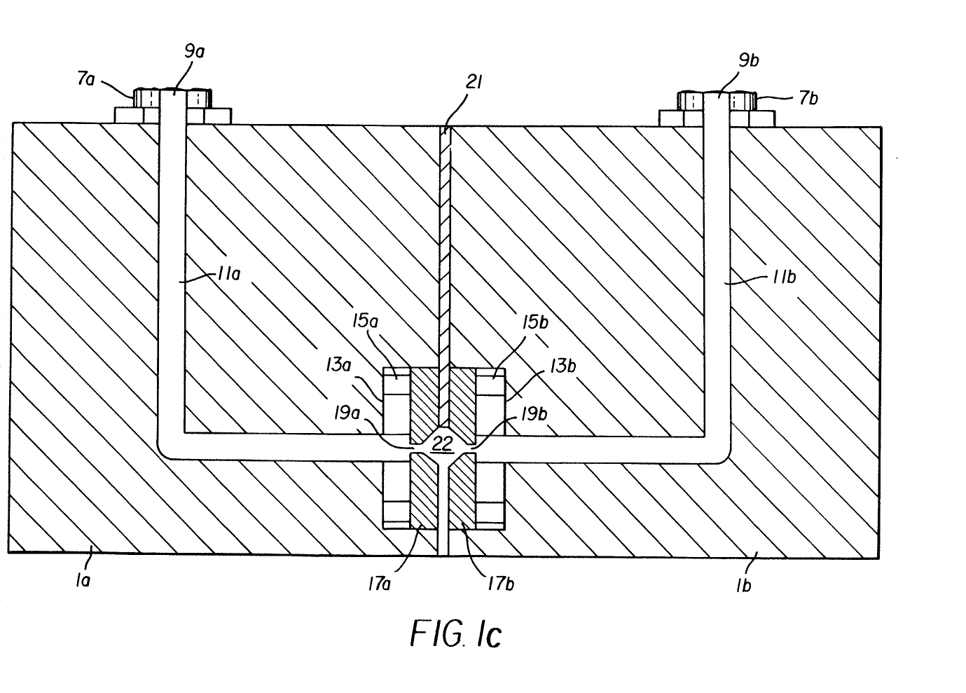

Referring to FIGS. 1a, 1b and 1c, there are shown views of a mixing chamber 2 of the present invention. The mixing chamber 2 includes two blocks 1a and 1b that are rigidly attached to each other via four bolts 3 secured on block 1b which are inserted into openings 5 in block 1a (only two are shown in FIG. 1b). Each block 1a and 1b contains an inlet 7a and 7b having a port 9a and 9b which is respectively connected to channels 11a and 11b (shown in FIGS. 1b and 1c) through which ports 9 and channels 11 each liquid is passed via a pump (not shown). Each block 1a and 1b includes a depression 13a and 13b on one of its faces for respectively holding an o-ring 15a and 15b. An orifice plate 17a and 17b is respectively disposed in each depression 13a and 13b. Each orifice plate 17a and 17b contains an opening 19a and 19b in its center having a diameter which is less than the diameter of the channels 11a and 11b to provide a restriction through which the liquid is forced by a pump (not shown) to produce a high-velocity jet stream. A jet stream as used herein is a flow of a fluid from a directed source into stationary surroundings. It may be apparent to those skilled in the art that, since the orifice plates 17a and 17b are not rigidly attached to the blocks, they can be interchanged with alternate orifice plates containing different openings.

A shim 21 is placed between the blocks 1a and 1b to provide a small volume 22 (preferably between 0.008 mm³ and 13 mm³ corresponding to an orifice diameter between 0.2 mm and 1.5 mm and a shim thickness between 0.25 mm and 1.8 mm) in which the liquids are mixed under conditions of high kinetic energy. The volume of the mixing zone within the chamber is defined as the area of the orifice times the thickness of the shim separating the orifices. It is desired that the volume of the mixing zone in the chamber is small enough so that the energy density between the colliding jets is maximized. In addition, it is desired that the region of maximum energy density is confined within the mixing zone in the smallest possible area at the moment of collision, but large enough so that the mixing energy is not absorbed by the bulk solution. The residence time which as used herein is the volume of the mixing zone divided by the flow rate of the two liquids, and is substantially 10 milliseconds or less and preferably 1 millisecond or less.

The lower part of the internal edge of the shim 21 is triangular shaped so that the two liquids meet at the apex of the triangle and are dispensed downward into the bulk stabilizer solution. The shim 21 is held in place by dowel pins 23 and bolts 3 that are attached to the block 1b and extend through holes 25 on the shim 21. Two openings 27 in the block 1a respectively receive the dowel pins 23. The shim 21 can be replaced by a different shim if a different thickness is desired to change the volume of the mixing zone.

The orifice openings 19 produce a jet stream that is dispensed into the jet impingement area 22, preferably with a velocity of at least 1 meter per second. The shim 21 is shaped at its bottom portion to provide a small volume mixing zone for the colliding jets. The two liquids collide within the mixing area 22 and the resulting product is a solid particle dispersion with substantially all particles below 1 micron which is immediately directed downward into a bulk stabilizer solution (not shown in FIG. 1).

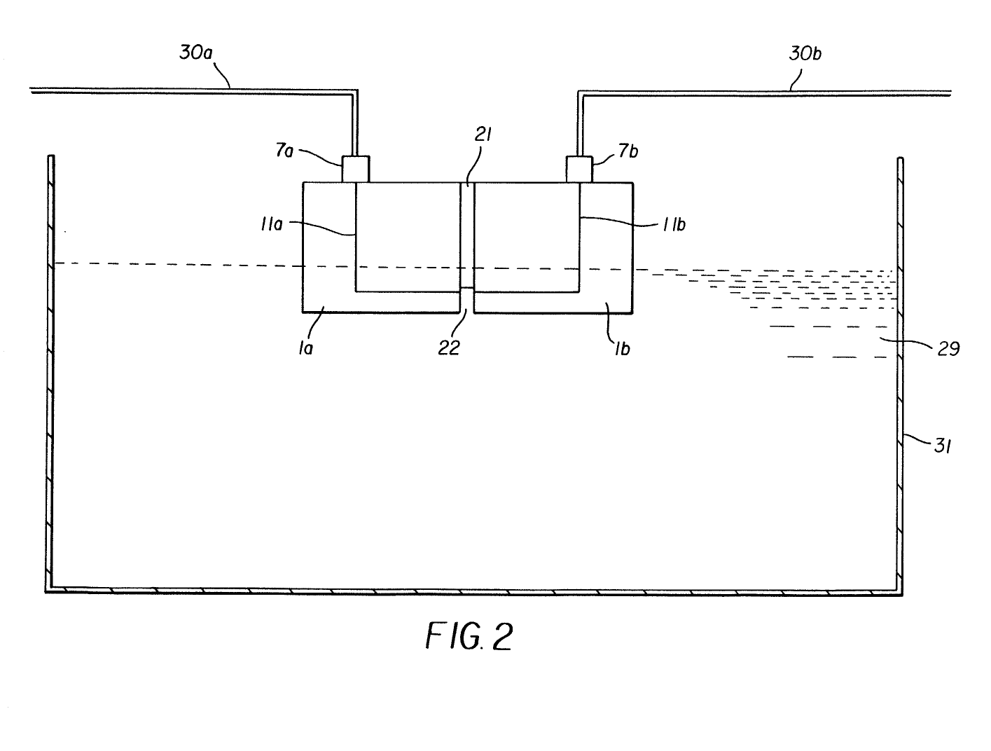

Referring to FIG. 2, there is shown the mixing chamber 2 disposed in the bulk stabilizer solution 29 for clarity of understanding. It is preferred that the level of the bulk stabilizer solution is at the same height or level as the apex of the upper internal edge of the shim 21 and the orifices 19. Each liquid enters ports 7a and 7b by pipes 30a and 30b from the pumps (not shown). As previously described, the liquids pass through channels 11a and 11b and react with each other through a high speed collision in the mixing zone 22 to produce a sub-micron solid precipitate. The resulting dispersion is immediately dispensed without restriction and quenched into the bulk solution 29. As used herein “without restriction” means the resultant sub-micron, solid particle dispersion with substantially all particles below 1 micron is immediately diluted into the bulk solution without first being restricted by walls of a channel or pipe. This is desired because the dilution in the bulk solution decreases the concentration of the solvent and contains stabilizers that prevent particle growth and agglomeration. The bulk solution 29 is contained in a container 31, and as may be apparent to those skilled in the art, the final mixed product disperses into the bulk solution from which the final product may be retrieved by means well known in the art. Preferably, the bulk solution 29 contains the non-solvent, typically water, and stabilizers, such as a surfactant and a polymeric dispersant. The temperature of the bulk solution can adjusted so that it provides a means to control the temperature of the dispersion after it is formed and discharged from the mixing chamber. It is to be noted the volume of the mixing zone 22 is significantly smaller than the bulk solution 29.

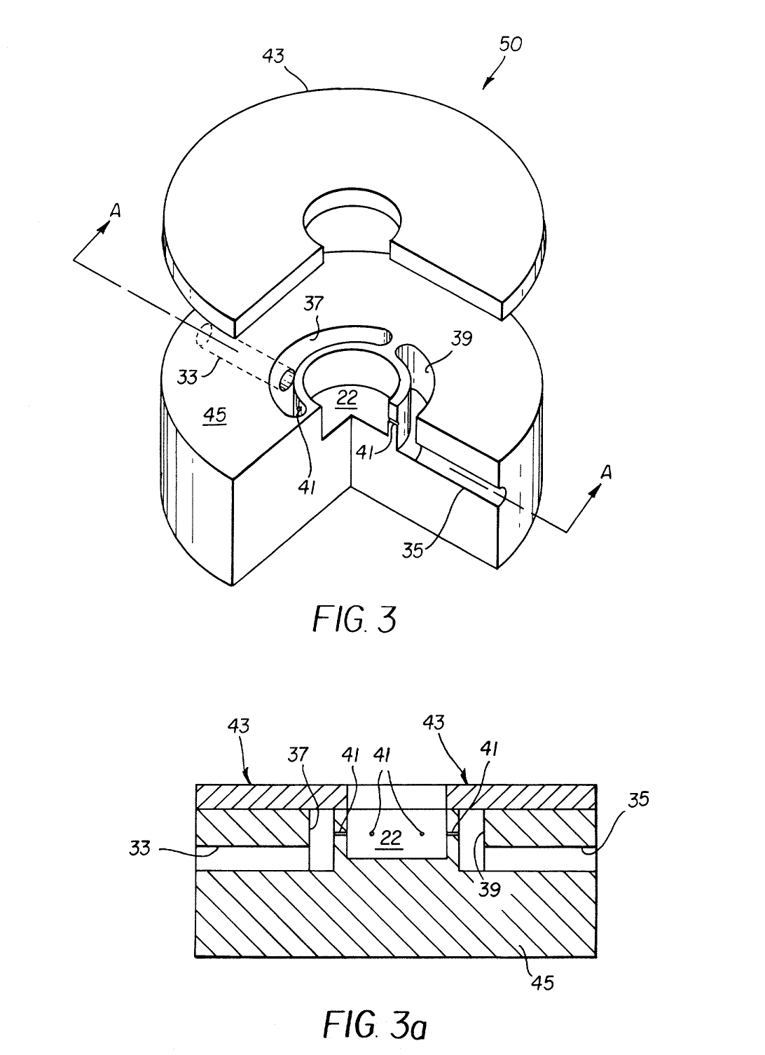

Referring to FIGS. 3 and 3a, there is shown an alternative embodiment of the present invention. The alternative system includes two pipes 33 and 35 for respectively forcing the liquids into a fluid channel 37 and 39. The fluid channels 37 and 39 both include a plurality of orifices 41, for example 3 orifices in the embodiment shown, for each producing a jet stream under high velocity into the mixing zone 22. The miscible liquids come into contact with each other for producing a solid precipitate as described hereinabove. The solid precipitate and liquid rapidly exit jet impingement mixing chamber 22 and flow into the bulk solution (not shown). A lid 43 is placed atop the steel encasement 45 for enclosing the fluid channels 37 and 39. Similarly to the mixing chamber 2, the mixing chamber 50 can also be wholly or partially submerged into the bulk stabilizer solution 29.

The invention has been described in detail with particular reference to certain preferred embodiments thereof, but it will be understood that variations and modifications can be effected within the spirit and scope of the invention.

### Parts List

1 blocks

2 mixing chamber

3 bolts

5 openings

7 inlets

9 ports

11 channels

13 depressions

15 o-rings

17 orifice plates

19 openings

21 shim

22 small volume mixing area

23 dowel pins

25 holes

27 openings

29 bulk stabilizer solution

30 pipes

31 container

33 pipe

35 pipe

37 channel

39 channel

41 orifices

43 lid

45 steel encasement

50 mixing chamber

What is claimed is:

1. A mixing chamber for mixing two or more liquids to produce a solid particle dispersion with substantially all particles below 1 micron, the mixing chamber comprising:
(a) a first channel for permitting flow of a first liquid under a first velocity;
(b) at least one jet-stream producing mechanism in operative relation to the first channel for dispensing the first miscible liquid therefrom under increased first velocity into a mixing zone;
(c) a second channel for permitting flow of a second liquid under a second velocity; and
(d) at least one jet-stream producing mechanism in operative relation to the second channel for dispensing the second liquid therefrom into the mixing zone under an increased second velocity into substantial contact with the first liquid;
wherein the solid particle dispersion with substantially all particles below 1 micron is formed from impact of the first and second liquids in the mixing zone in which residence time of the first and second liquids in the mixing zone is substantially 10 milliseconds or less, and the solid particle dispersion with substantially all particles below 1 micron formed as a result of the impact is immediately dispensed into a bulk stabilizer solution without further restriction.

2. The mixing chamber as in claim 1, wherein the residence time is substantially 1 millisecond or less.

3. The mixing chamber as in claim 1, wherein the mixing zone is substantially between 0.008 mm³ and 13 mm³.

4. The mixing chamber as in claim 1, wherein the jet-producing mechanisms are orifices contained in a plate, and the orifices contain a diameter less than the diameter of the channel.

5 The mixing chamber as in claim 4, wherein the plates containing the orifices are interchangeable so that a plurality of small mixing volumes can be produced.

6. The mixing chamber as in claim 1 further comprising two blocks each containing one of the two channels and a shim separates the two blocks.

7. The mixing chamber as in claim 6, wherein the shim is interchangeable so that a plurality of small mixing volumes can be produced.

8. The mixing chamber as in claim 1, wherein the jet-stream producing mechanisms produce a minimum velocity of substantially 1 meter per second.

9. The mixing chamber as in claim 1, wherein the jet-stream producing mechanisms produce jets impinging at one hundred eighty degrees.

10. The mixing chamber as in claim 1, wherein the jet-stream mechanism is an arcuate shaped channel having a plurality of orifices.
